(19) United States
(12) Patent Application Publication
(10) Pub. No.: US 2009/0135228 A1
(43) Pub. Date: May 28, 2009

(54) INKJET PRINTHEAD AND METHOD OF EJECTING INK USING THE SAME

(75) Inventors: You-seop LEE, Yongin-si (KR); Keon Kuk, Yongin-si (KR); Dong-kee Sohn, Seoul (KR); Yong-soo Lee, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/114,041

(22) Filed: May 2, 2008

(30) Foreign Application Priority Data
Nov. 28, 2007 (KR) 2007-121996

(51) Int. Cl. B41J 2/06

(52) U.S. Cl. 347/55

(57) ABSTRACT

An inkjet printhead including a passage plate in which a manifold to supply ink and a nozzle to eject ink are formed; a first electrode and a second electrode formed on the passage plate around the nozzle to generate an ion wind by ionizing air between the first and second electrodes by a voltage that is applied between the first and second electrodes, and a third electrode and a fourth electrode to generate an electrostatic force by a voltage applied between the third and fourth electrodes, wherein the third electrode is separated from the passage plate and the fourth electrode is formed on the passage plate.

### CROSS-REFERENCE TO RELATED APPLICATIONS

This application claims priority under 35 U.S.C. §119(a) from Korean Patent Application No. 10-2007-0121996, filed on Nov. 28, 2007, in the Korean Intellectual Property Office, the disclosure of which is incorporated herein in its entirety by reference.

### BACKGROUND OF THE INVENTION

1. Field of the Invention

The present general inventive concept relates to an inkjet printhead, and more particularly, to an inkjet printhead using an ion wind and electrostatic force, and a method of ejecting ink using the inkjet printhead.

2. Description of the Related Art

In general, an inkjet printhead forms images of predetermined colors by ejecting minute ink droplets at desired position of a print medium. Inkjet printheads can be classified into two types according to the ink ejection mechanism: a thermal driving inkjet printhead that generates bubbles in ink using a heat source, thereby ejecting ink droplets due to an expanding force of the bubbles, and a piezoelectric driving printhead using a piezoelectric body, thereby ejecting ink droplets using a pressure applied to ink due to deformation of the piezoelectric body.

Recently, inkjet printheads using a new ink ejection method have been developed. U.S. Pat. No. 7,216,958 discloses, for example, an inkjet printhead including a pair of electrodes to generate ion wind and ejecting ink by the ion wind.

### SUMMARY OF THE INVENTION

The present general inventive concept provides an inkjet printhead using ion wind and electrostatic force.

The present general inventive concept also provides a method of ejecting ink using the inkjet printhead using ion wind and electrostatic force.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an inkjet printhead including a passage plate in which a manifold to supply ink and a nozzle to eject ink are formed, a first electrode and a second electrode formed on the passage plate around the nozzle to generate an ion wind by ionizing air between the first and second electrodes when a voltage is applied between the first and second electrodes, and a third electrode and a fourth electrode to generate an electrostatic force when a voltage is applied between the third and fourth electrodes, wherein the third electrode is separated from the passage plate and the fourth electrode is formed on the passage plate.

The ion wind generated by the first and second electrodes may flow in the direction away from the second electrode toward an outlet of the nozzle, and rise in front of the outlet of the nozzle.

The first electrode may be formed to surround an outlet of the nozzle, and the second electrode may be formed to surround the first electrode. The second electrode may have a smaller cross-section than the first electrode. At least one protrusion may be formed in the second electrode toward the first electrode.

A groove may be formed on the passage plate around the nozzle to a predetermined depth to surround the nozzle, and the first and second electrodes may be formed inside the groove. A surface of the groove toward the nozzle may be inclined such that the ion wind generated by the first and second electrodes flows at an inclined angle toward the front of the outlet of the nozzle.

An ion wind passage to guide the ion wind generated by the first and second electrodes may be formed on the passage plate around the nozzle to surround the nozzle, and the first and second electrodes may be formed in the ion wind passage. An air supply passage may be formed on the passage plate to connect to the ion wind passage.

A printing medium may be provided on the third electrode. The fourth electrode may be formed as a single body with the first electrode or the second electrode. A plurality of the nozzles may be formed in the passage plate, and the first and second electrodes may correspond to each of the nozzles.

The foregoing and/or other aspects and utilities of the present general inventive concept may also be achieved by providing a method of ejecting ink using an inkjet printhead comprising a passage plate having a manifold to supply ink, a nozzle to eject ink, a first and second electrode formed around the nozzle to generate an ion wind, and a third electrode and a fourth electrode to generate an electrostatic force, wherein the third electrode is separate from the passage plate and the fourth electrode is formed on the passage plate, the method including generating an ion wind by applying a predetermined voltage between the first electrode and the second electrode, and ejecting ink from the nozzle by forming an electrostatic field between the third electrode and the fourth electrode by applying a predetermined voltage between the third electrode and the fourth electrode while the ion wind is flowing toward an outlet of the nozzle.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a cross-sectional view illustrating an inkjet printhead according to an embodiment of the present general inventive concept;

FIG. 2 is a plane view illustrating a first electrode and a second electrode formed around a nozzle in the inkjet printhead illustrated in FIG. 1;

FIG. 3 is a plane view illustrating another example of the first and second electrodes of FIG. 2;

FIGS. 4A and 4B illustrate a method of ejecting ink using the inkjet printhead illustrated in FIG. 1;

FIGS. 5A and 5B illustrate a method of ejecting ink using the inkjet printhead illustrated in FIG. 1, according to another embodiment of the present general inventive concept;

FIG. 6 is a cross-sectional view illustrating the inkjet printhead of FIG. 1 including a plurality of nozzles;

FIG. 7 is a cross-sectional view illustrating an inkjet printhead according to another embodiment of the present general inventive concept; and

FIG. 8 is a cross-sectional view illustrating an inkjet printhead according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

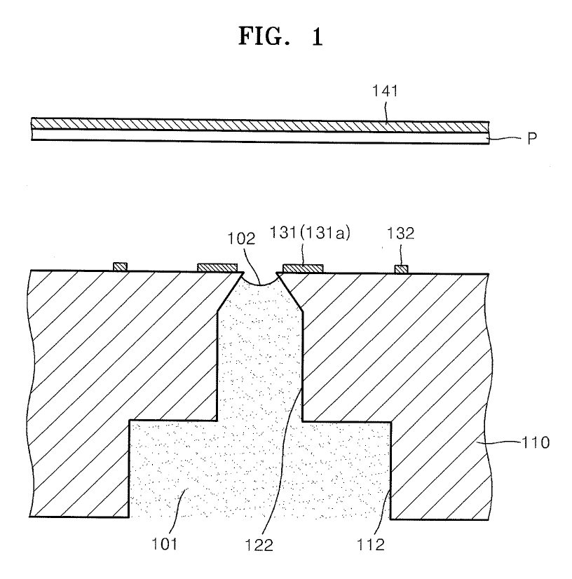

FIG. 1 is a cross-sectional view illustrating an inkjet printhead according to an embodiment of the present general inventive concept.

Referring to FIG. 1, the inkjet printhead according to the current embodiment may include a passage plate 110 in which a manifold 112 and a nozzle 122 are formed, a pair of electrodes to generate an ion wind therebetween in response to an applied voltage, and a pair of electrodes to generate an electrostatic force therebetween in response to an applied voltage.

In detail, the nozzle 122, through which ink 101 is ejected, and the manifold 112 to supply ink 101 to the nozzle 122 are formed in the passage plate 110. Ink 101 is filled in the nozzle 122 from the manifold 112 by a capillary force. Ink 101 is supplied to the manifold 112 from an ink reservoir (not illustrated). A cross-section of the nozzle 122 may preferably be a circle, but may also be an oval, polygon, etc. An end at an outlet of the nozzle 122 may be tapered, having a cross-section that is gradually reduced. Reference numeral 102 denotes a meniscus of ink 101 inside the nozzle 122.

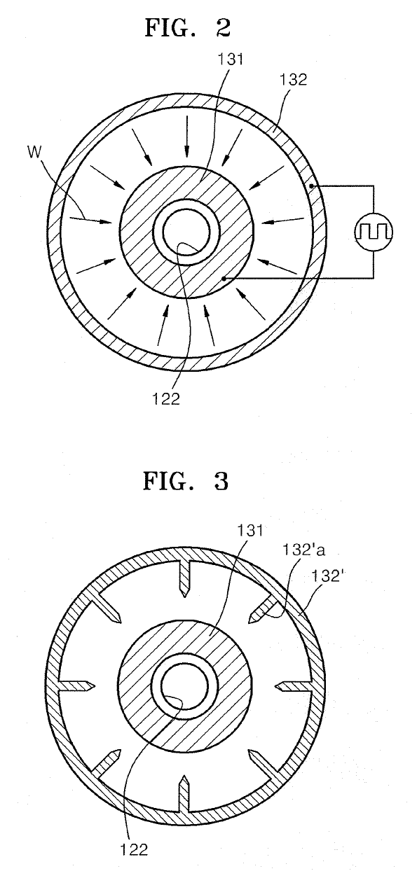

A first electrode 131 and a second electrode 132 to generate an ion wind are formed on the passage plate 110 around the outlet of the nozzle 122. FIG. 2 is a plane view of the first electrode 131 and the second electrode 132 of FIG. 1. Referring to FIG. 2, the first electrode 131 may be disposed near the outlet of the nozzle 122, and the second electrode 132 may be disposed away from the outlet of the nozzle 122. The first electrode 131 may be formed to surround the outlet of the nozzle 122, and the second electrode 132 may be formed to surround the first electrode 131. For example, as illustrated in FIG. 2, when the cross-section of the nozzle 122 is a circle, the first and second electrodes 131 and 132 also have a round shape. If the cross-section of the nozzle 122 is not a circle, the shape of the first and second electrodes 131 and 132 may also vary. The second electrode 132 may be formed to have a smaller cross-section than the first electrode 131, and may be formed to be spaced apart from the first electrode.

In FIG. 2, when a predetermined voltage, for example, a direct current voltage or a pulse voltage that is sufficient to ionize air, is applied between the first and second electrodes 131 and 132, a predetermined electric field is formed between the first and second electrodes 131 and 132, and thus a discharge is generated. Here, a voltage of about several tens to several hundreds volts (V) can be applied between the first and second electrodes 131 and 132. The air around the first and second electrodes 131 and 132 is ionized by the discharge, and the ionized air receives a Coulomb force in the electric field and is moved toward the first electrode 131. Accordingly, an ion wind W is generated. The ion wind W flows in the direction away from the second electrode 132 toward the outlet of the nozzle 122, and rises in front of the outlet of the nozzle 122. The speed of the ion wind W increases as the Coulomb force the ionized air receives in the electric field is increased. In other words, the higher the voltage applied between the first and second electrodes 131 and 132, the faster the ion wind W. Thus, when the ion wind W is generated around the outlet of the nozzle 122, air pressure at the outlet of the nozzle 122 is decreased, and accordingly, as will be described later, the meniscus 102 of the ink 101 in the nozzle 122 protrudes to an outside, or the ink 101 in the nozzle 122 can be ejected to the outside.

FIG. 3 is a plane view of a second electrode 132′ according to another embodiment of the present general inventive concept as another example of the second electrode 132 of FIG. 2. Referring to FIG. 3, at least one protrusion 132′a is formed in the second electrode 132′ that surrounds the first electrode 131. A plurality of protrusions 132′a may be formed at equivalent intervals. When the protrusions 132′a are formed in the second electrode 132′, a higher electric field can be generated at ends of the protrusions 132′a, and thus an ion wind W having sufficient speed can be generated with a lower voltage.

The inkjet printhead according to the current embodiment of the present general inventive concept may include a pair of electrodes including a third electrode 141 and a fourth electrode (reference numeral 131a in FIG. 1). The third electrode 141 is formed separated a predetermined distance from the passage plate 110, and a printing medium P can be provided on the third electrode 141. The fourth electrode 131a is formed on the passage plate 110. The fourth electrode 131a may be formed separately on the passage plate 110, or may be formed as a single body with the first electrode 131 or the second electrode 132. In FIG. 1, the fourth electrode 131a is illustrated as formed as a single body with the first electrode 131. However, the present general inventive concept is not limiter thereto, and the fourth electrode 131a may also be separately provided. casein the current embodiment, where the fourth electrode 131a is formed as a single body with the first electrode 131, the first electrode 131 functions as an electrode to generate an ion wind W between the first electrode 131 and the second electrode 132, and also functions as an electrode to generate an electrostatic force between the first electrode 131 and the third electrode 141. When a predetermined voltage is applied between the first electrode 131 and the third electrode 141, an electrostatic field is formed, and the ink 101 in the nozzle 122 receives an electrostatic force toward the third electrode 141 on which the printing medium P is provided, by the electrostatic force.

Hereinafter, a method of ejecting ink using the inkjet printhead according to the current embodiment of the present general inventive concept will be described in detail.

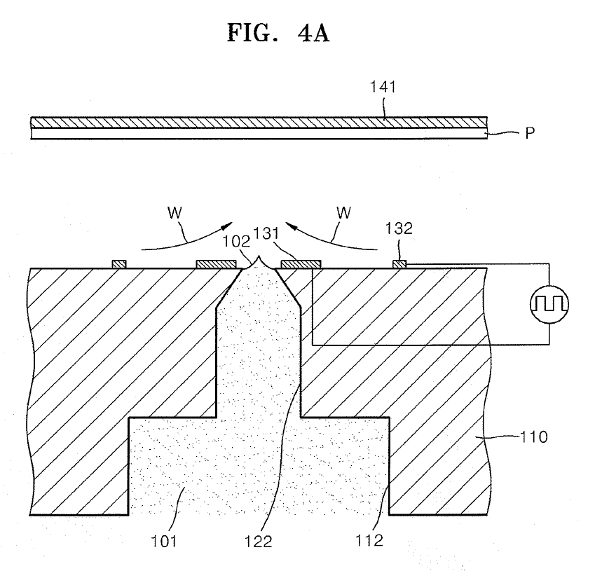

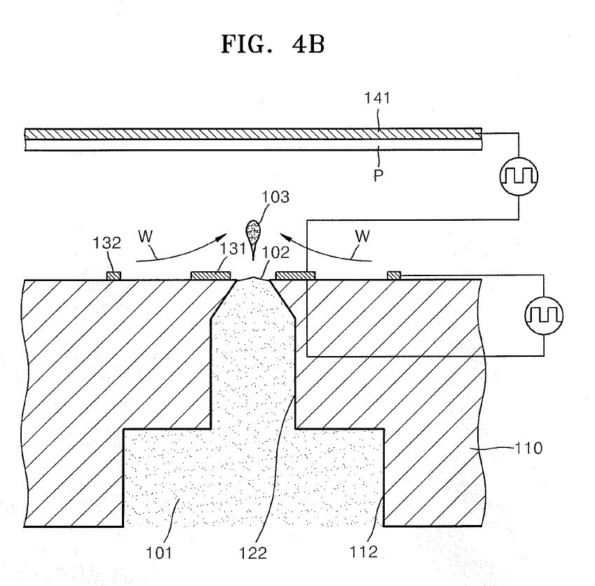

FIGS. 4A and 4B illustrate a method of ejecting ink using the inkjet printhead illustrated in FIG. 1.

First, referring to FIG. 4A, a predetermined voltage is applied between the first electrode 131 and the second electrode 132, while ink 101 supplied from the manifold 112 fills the nozzle 122 by capillary force. A pulse voltage or a direct current voltage may be applied between the first electrode 131 and the second electrode 132. Here, the voltage applied between the first electrode 131 and the second electrode 132 generates an ion wind W having a speed that does not eject the ink 101 in the nozzle 122 but can protrude a meniscus 102 of the ink 101 to an outside, as will be described later. That is, a discharge is generated by an electric field formed between the first electrode 131 and the second electrode 132, and the air between the first electrode 131 and the second electrode 132 is ionized by this discharge. As the ionized air receives a Coulomb force, the ionized air is moved toward the first electrode 131, and thus an ion wind W is generated. The ion wind W flows in the direction away from the second electrode 132 toward the outlet of the nozzle 122 and rises in front of the outlet of the nozzle 122, and thus an air pressure at the outlet of the nozzle 122 is decreased. Accordingly, the meniscus 102 of the ink 101 in the nozzle 122 protrudes to the outside as illustrated in FIG. 4A.

Next, referring to FIG. 4B, while the meniscus 102 of the ink 101 inside the nozzle 122 protrudes to the outside by the ion wind W, a predetermined voltage is applied between the first electrode 131 and the third electrode 141. Here, a pulse voltage or a direct current voltage can be applied between the first electrode 131 and the third electrode 141. Thus, when a predetermined voltage is applied between the first electrode 131 and the third electrode 141, a predetermined electrostatic field is formed between the first electrode 131 and the third electrode 141. Then, the ink 101 in the nozzle 122 whose meniscus 102 is protruded to the outside by the electrostatic force generated by the electrostatic field is ejected as a droplet 103 toward the third electrode 141. The ejected droplet 103 arrives on the printing medium P on the third electrode 141.

Thus, according to the present general inventive concept, after the meniscus 102 of the ink 101 in the nozzle 122 protrudes to the outside using the ion wind W, the ink 101 in the nozzle 122 is ejected on the printing medium P using electrostatic force.

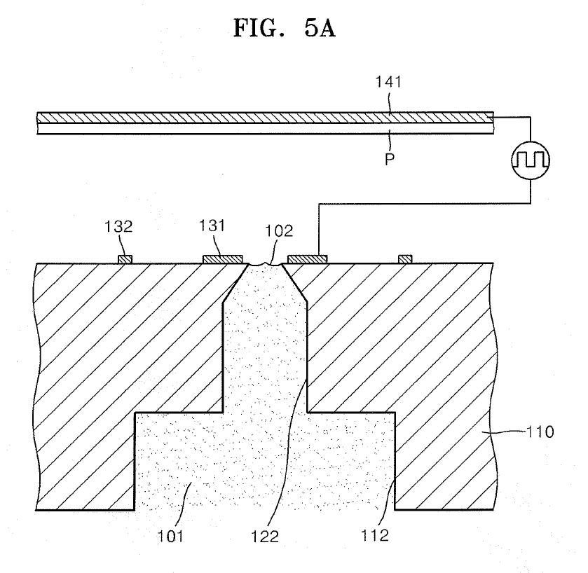

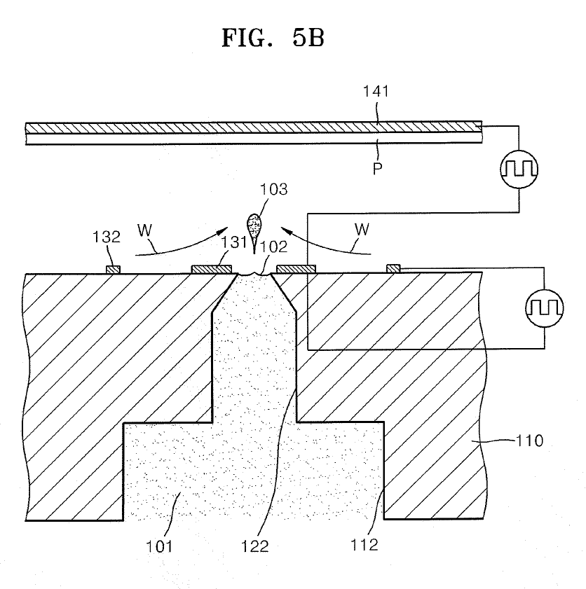

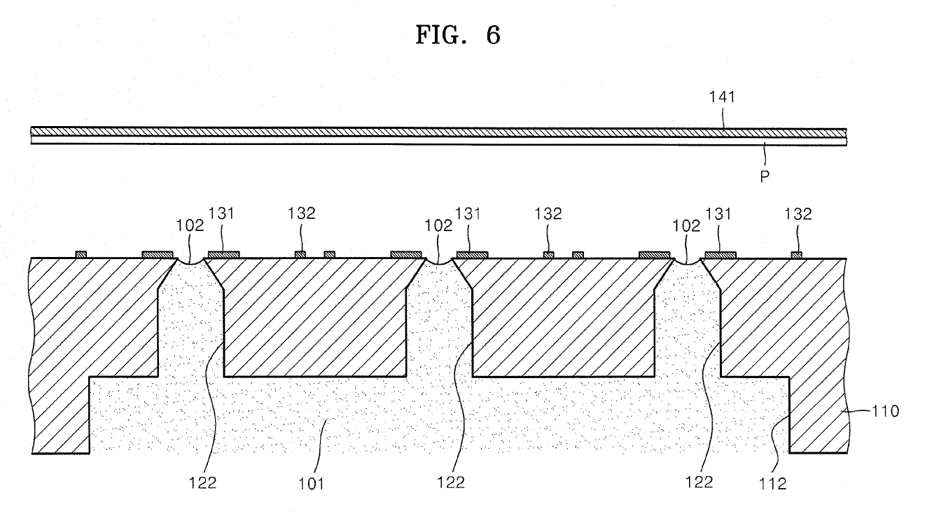

FIGS. 5A and 5B illustrate a method of ejecting ink using the inkjet printhead illustrated in FIG. 1, according to another embodiment of the present general inventive concept.

First, referring to FIG. 5A, while ink 101 supplied from the manifold 112 fills the nozzle 122 by capillary force, a predetermined voltage is applied between the first electrode 131 and the third electrode 141. Here, a pulse voltage or a direct current voltage can be applied between the first electrode 131 and the third electrode 141. Here, a voltage that is lower than a voltage to generate electrostatic force to eject the ink 101 in the nozzle 122 to an outside is applied between the first electrode 131 and the third electrode 141. Thus, when a voltage is applied between the first electrode 131 and the third electrode 141, a predetermined electrostatic field is formed between the first electrode 131 and the third electrode 141. The ink 101 in the nozzle 122 receives an electrostatic force toward the third electrode 141 by the electrostatic field formed in this manner. Accordingly, the meniscus 102 of the ink 101 in the nozzle 122 may protrude to the outside as illustrated in FIG. 5A. Meanwhile, in this case, the meniscus 102 of the ink 101 may not protrude to the outside but maintain an initial state.

Next, referring to FIG. 5B, while an electrostatic field is formed between the first electrode 131 and the third electrode 141, a predetermined voltage is applied between the first electrode 131 and the second electrode 132. A pulse voltage or a direct current voltage can be applied between the first electrode 131 and the second electrode 132. Next, a discharge is generated by an electric field formed between the first electrode 131 and the second electrode 132, and the air between the first electrode 131 and the second electrode 132 is ionized by this discharge. As the ionized air receives a Coulomb force, the ionized air is moved toward the first electrode 131, and thus an ion wind W is generated. The ion wind W flows in the direction away from the second electrode 132 to the outlet of the nozzle 122, and rises in front of the outlet of the nozzle 122. Accordingly, the air pressure at the outlet of the nozzle 122 decreases. Due to the decreased air pressure, the ink 101 in the nozzle 122 is ejected as a droplet 103 toward the third electrode 141. The ejected ink droplet 103 arrives on the printing medium P on the third electrode 141.

Accordingly, according to the current embodiment of the present general inventive concept, the ink 101 in the nozzle 122 receives an electrostatic force toward the printing medium P, and thus the ink 101 in the nozzle 122 is ejected toward the printing medium P using the ion wind W.

FIG. 6 is a cross-sectional view illustrating an example of the inkjet printhead of FIG. 1 including a plurality of nozzles.

Referring to FIG. 6, a manifold 112 is formed in a passage plate 110, and a plurality of nozzles 122 connected with the manifold 112 are arranged in three rows. In FIG. 6, the nozzles 122 are arranged in three rows, but they may be arranged in two rows or in four rows or more in order to increase printing resolution. Then, a first electrode 131 and a second electrode 132 are formed around each of the nozzles 122, as described above.

In such configuration, ink can be ejected in two ways, as described above. First, an ion wind W can be generated between the first and second electrodes 131 and 132 corresponding to the nozzles 122 through which ink is ejected, and a meniscus 102 of ink 101 in the nozzles 122 protrudes to an outside, and then an electrostatic force is generated between the first electrode 131 and the third electrode 141 corresponding to the nozzles 122 to eject the ink 101 in the nozzles 122 onto the printing medium P.

Second, a voltage may be between the first and third electrodes 131 and 141 corresponding to the nozzles 122 through which ink is desired to be ejected, such that the ink 101 in the nozzles 122 receives an electrostatic force toward the third electrode 141, and then an ion wind W is generated between the first and second electrodes 131 and 132, thereby ejecting the ink 101 in the nozzles 122 on the printing medium P.

As described above, according to the current embodiment the present general inventive concept, since a structure of the inkjet printhead is simple, the nozzles 122 can be highly integrated, and thus an inkjet printhead with high resolution can be manufactured. Also, since power consumed to generate an ion wind W is very small, an inkjet printhead with low power consumption can be manufactured. Also, whereas a thermal inkjet printhead requires retreat of an ink meniscus and a refill process due to collapse of bubbles, in the current embodiment of the present general inventive concept, as there is no retreat process of an ink meniscus and no refill process, high speed printing can be realized. Meanwhile, whereas electrical crosstalk may be generated between nozzles in an electrostatic inkjet printhead including a plurality of nozzles, in the present general inventive concept, ink is ejected using an ion wind while an electrostatic field is generated, and thus electrical crosstalk between nozzles can be prevented.

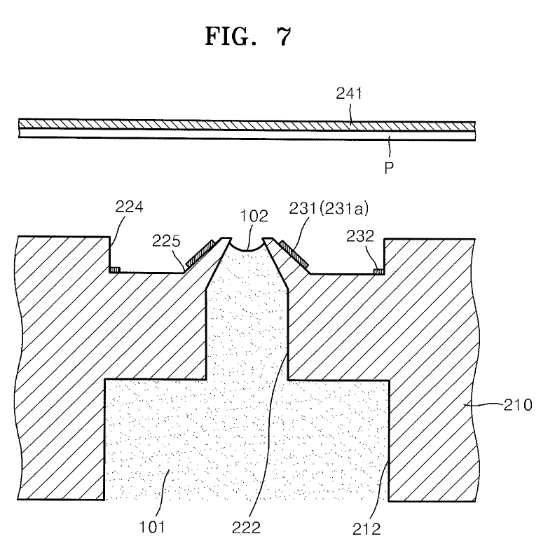

FIG. 7 is a cross-sectional view of an inkjet printhead according to another embodiment of the present general inventive concept. Hereinafter, mainly features different from the embodiment of FIG. 1 will be further explained.

Referring to FIG. 7, a manifold 212 to supply ink 101 and a nozzle 222 through which the ink 101 is ejected are formed in a passage plate 210. Here, the ink 101 is supplied from the manifold 212 and fills the nozzle 222 by capillary force. A groove 224 is formed to a predetermined depth to surround the nozzle 222 on the passage plate 210 around the nozzle 222. Also, a first and second electrode 231 and 232 to generate an ion wind are arranged in the groove 224. The first electrode 231 may be formed to surround the nozzle 222, and the second electrode 232 may be formed to surround the first electrode 231. Meanwhile, protrusions may be formed in the second electrode 232, as illustrated in FIG. 3, toward the first electrode 231. Also, a surface 225 at the nozzle 222 of the groove 224 may be inclined so that the ion wind generated by the first and second electrodes 231 and 232 can flow at an inclined angle in the groove 224 toward a front of the outlet of the nozzle 222 so that the ion wind generated by the first and second electrodes 231 and 232 rises more easily in front of the outlet of the nozzle 222. In this case, the first electrode 231 can be formed on the inclined surface 225 of the groove 224, as illustrated in FIG. 7, in order to ease the flow of the ion wind. The second electrode 232 may be formed on a bottom surface and at the outer circumference of the groove 224.

A third electrode 241 is separated a predetermined distance from the passage plate 210, and a printing medium P is provided on the third electrode 241. Also, a fourth electrode (reference numeral 231a in FIG. 7) is provided on the passage plate 210. When a predetermined voltage is applied between the third electrode 241 and the fourth electrode 231a, an electrostatic field is generated therebetween, and the ink 101 in the nozzle 222 receives an electrostatic force via the electrostatic field. The fourth electrode 231a may be formed as a single body with the first electrode 231 or the second electrode 232. Alternatively, the fourth electrode 231a may be separately formed on the passage plate 210. In FIG. 7, the fourth electrode 231a is formed in a single body with the first electrode 231. The inkjet printhead according to the current embodiment may also have a plurality of nozzles 222, as illustrated in FIG. 6.

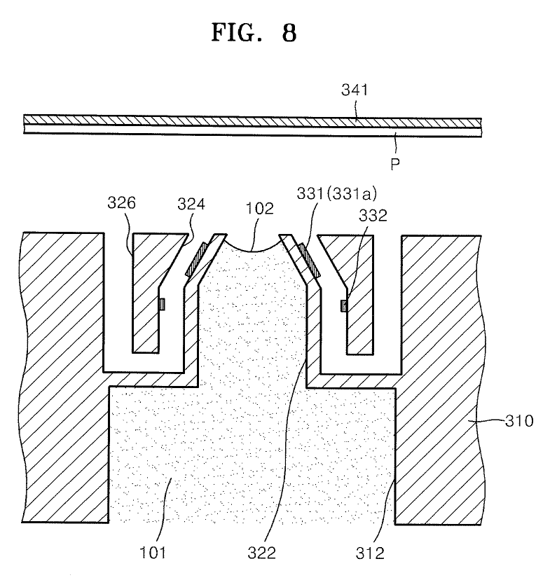

FIG. 8 is a cross-sectional view of an inkjet printhead according to another embodiment of the present general inventive concept. Hereinafter, mainly features different from the embodiment of FIG. 1 will be further explained.

Referring to FIG. 8, a manifold 312 to supply ink and a nozzle 322, through which ink is ejected, are formed in a passage plate 310. Here, ink 101 is supplied from the manifold 312 by capillary force to the nozzle 322. Also, an ion wind passage 324 to guide an ion wind generated by first and second electrodes 331 and 332 is formed on the passage plate 310 around the nozzle 322 to surround the nozzle 322. The first and second electrodes 331 and 332 may be formed inside the ion wind passage 324. The first electrode 331 may be formed to surround the nozzle 322, and the second electrode 332 may be formed to surround the first electrode 331. Meanwhile, as illustrated in FIG. 3, protrusions may be formed in the second electrode 332 toward the first electrode 331. An end portion at the outlet of the ion wind passage 324 may be inclined so that an ion wind generated in the ion wind passage 324 can flow at an inclined angle toward the front of the outlet of the nozzle 322, that is, the ion wing can flow easily in front of the outlet of the nozzle 332. The first electrode 331 may be disposed on the inclined surface of the ion wind passage 324, and the second electrode 332 can be separated a predetermined distance from the first electrode 331.

Also, an air supply passage 326 to supply the ion wind passage 324 with air can be formed to be connected to the ion wind passage 324 in the passage plate 310. The air supply passage 326 may be formed in a perpendicular direction to a surface of the passage plate 310 as illustrated in FIG. 8, and can be connected to the ion wind passage 324 at a lower end of the air supply passage 326. The air supply passage 326 can be also formed in a parallel direction to the surface of the passage plate 310, or at an inclined angle. In other words, as long as air can be supplied to the ion wind passage 324, a position and shape of the air supply passage 326 can be modified in various ways.

A third electrode 341 is separated a predetermined distance from the passage plate 310, and a printing medium P may be provided on the third electrode 341. Also, a fourth electrode (reference numeral 331a in FIG. 8) is provided on the passage plate 310. When a predetermined voltage is applied between the third electrode 341 and the fourth electrode, an electrostatic field is formed between the third electrode 341 and the fourth electrode, and the ink 101 inside the nozzle 322 receives an electrostatic force. The fourth electrode 331a may be formed in a single body with the first electrode 331 or the second electrode 332. Also, the fourth electrode 331a may be separately formed on the passage plate 310. In FIG. 8, the fourth electrode 331a is formed in a single body with the first electrode 331. Meanwhile, the inkjet printhead according to the current embodiment may include a plurality of nozzles 322 as illustrated in FIG. 6.

The method of ejecting ink using the above-described inkjet printhead illustrated in FIGS. 7 and 8 is similar to the method described with reference to FIGS. 4A and 4B and the method described with reference to FIGS. 5A and 5B, and thus will not be repeated.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet printhead comprising:
a passage plate in which a manifold to supply ink and a nozzle to eject ink are formed;
a first electrode and a second electrode formed on the passage plate around the nozzle to generate an ion wind by ionizing air between the first and second electrodes when a voltage is applied between the first and second electrodes; and
a third electrode and a fourth electrode to generate an electrostatic force when a voltage is applied between the third and fourth electrodes, wherein the third electrode is separated from the passage plate and the fourth electrode is formed on the passage plate.

2. The inkjet printhead of claim 1, wherein the ion wind generated by the first and second electrodes flows in the direction away the second electrode toward an outlet of the nozzle, and rises in front of the outlet of the nozzle.

3. The inkjet printhead of claim 1, wherein the first electrode is formed to surround an outlet of the nozzle and the second electrode is formed to surround the first electrode.

4. The inkjet printhead of claim 3, wherein the second electrode has a smaller cross-section than the first electrode.

5. The inkjet printhead of claim 3, wherein at least one protrusion is formed in the second electrode toward the first electrode.

6. The inkjet printhead of claim 3, wherein a groove is formed on the passage plate around the nozzle to a predetermined depth to surround the nozzle, and the first and second electrodes are formed inside the groove.

7. The inkjet printhead of claim 6, wherein a surface of the groove toward the nozzle is inclined such that the ion wind generated by the first and second electrodes flows at an inclined angle toward the front of the outlet of the nozzle.

8. The inkjet printhead of claim 3, wherein an ion wind passage to guide the ion wind generated by the first and second electrodes is formed on the passage plate around the nozzle to surround the nozzle, and the first and second electrodes are formed in the ion wind passage.

9. The inkjet printhead of claim 8, wherein an air supply passage is formed on the passage plate to connect to the ion wind passage.

10. The inkjet printhead of claim 1, wherein a printing medium is provided on the third electrode.

11. The inkjet printhead of claim 1, wherein the fourth electrode is formed as a single body with the first electrode or the second electrode.

12. The inkjet printhead of claim 1, wherein a plurality of the nozzles are formed in the passage plate, and the first and second electrodes correspond to each of the nozzles.

13. A method of ejecting ink using an inkjet printhead comprising a passage plate having a manifold to supply ink, a nozzle to eject ink, a first and second electrode formed around the nozzle to generate an ion wind, and a third electrode and a fourth electrode to generate an electrostatic force, wherein the third electrode is separate from the passage plate and the fourth electrode is formed on the passage plate, the method comprising:
generating an ion wind by applying a predetermined voltage between the first electrode and the second electrode; and
ejecting ink from the nozzle by forming an electrostatic field between the third electrode and the fourth electrode by applying a predetermined voltage between the third electrode and the fourth electrode while the ion wind is flowing toward an outlet of the nozzle.

14. The method of claim 13, wherein the ion wind generated by the first and second electrodes flows in the direction away from the second electrode toward the outlet of the nozzle and rises in front of the outlet of the nozzle.

15. The method of claim 14, wherein a meniscus of the ink inside the nozzle protrudes to the outside by the ion wind.

16. The method of claim 13, wherein ink inside the nozzle is ejected toward the third electrode by an electrostatic force generated between the third and fourth electrodes.

17. The method of claim 13, wherein the fourth electrode is formed as a single body with the first or second electrode.

18. A method of ejecting ink using an inkjet printhead comprising a passage plate having a manifold to supply ink, a nozzle to eject ink, a first and second electrode formed around the nozzle to generate an ion wind, and a third electrode and a fourth electrode to generate an electrostatic force, wherein the third electrode is separate from the passage plate and the fourth electrode is formed on the passage plate, the method comprising:
forming an electrostatic field by applying a predetermined voltage between the third electrode and the fourth electrode; and
ejecting ink from the nozzle by generating an ion wind between the first and second electrodes by applying a predetermined voltage between the first and second electrodes, while an electrostatic field is formed between the third and fourth electrodes.

19. The method of claim 18, wherein the ink inside the nozzle receives an electrostatic force toward the third electrode due to the electrostatic field formed between the third and fourth electrodes.

20. The method of claim 19, wherein the ion wind generated by the first and second electrodes flows in the direction away from the second electrode toward the outlet of the nozzle, and rises in front of the outlet of the nozzle.

21. The method of claim 20, wherein the ink inside the nozzle is ejected toward the third electrode by the ion wind.

22. The method of claim 18, wherein the fourth electrode is formed in a single body with the first or second electrode.
